(19) United States
(12) Patent Application Publication
(10) Pub. No.: US 2010/0198678 A1
(43) Pub. Date: Aug. 5, 2010

(54) METHOD AND SYSTEM FOR SHARING OFFERS

(76) Inventors: Shawn Michael Burst, Mandeville, LA (US); Angelina Burst, Mandeville, LA (US)

Correspondence Address: MAYBACK & HOFFMAN, P.A., 5722 S. FLAMINGO ROAD #232, FORT LAUDERDALE, FL, 33330, US

(21) Appl. No.: 12/755,353

(22) Filed: Apr. 6, 2010

Related U.S. Application Data
(63) Continuation-in-part of application No. 12/433,363, filed on Apr. 30, 2009.
(60) Provisional application No. 61/049,193, filed on Apr. 30, 2008.

(51) Int. Cl. G06Q 30/00

(52) U.S. Cl. 705/14.39

(57) ABSTRACT

A method for stimulating commerce includes the steps of presenting an offer to a consumer, receiving from the consumer an identifier of a mode for sharing the offer, dynamically generating a unique URL, and placing the dynamically-generated URL in the selected mode for sharing the offer, where the dynamically-generated URL is selectable by a user. The unique URL includes at least an identifier of the consumer, the identifier of the mode for sharing the offer, and/or an identifier of the offer.

### CROSS-REFERENCE TO RELATED APPLICATION

This application is a continuation in part of U.S. patent application Ser. No. 12/433,363, filed Apr. 30, 2009, which parent application claims the priority of U.S. Provisional Patent Application No. 61/049,193 filed Apr. 30, 2008, the entire disclosure of which is hereby incorporated herein by reference in its entirety.

### FIELD OF THE INVENTION

This invention relates in general to coupons and gift cards, and more particularly, to coupons and gift cards that are associated with a commercial entity and are remotely activatable by a consumer from a location different from the physical location of the commercial entity where they can be used.

### BACKGROUND OF THE INVENTION

Millions of coupons and gift cards are placed in the mail and sent to potential consumers each day. Some of these products involve cooperative advertising by multiple merchants. One example is cut-and-stacked postcard decks. With postcard decks, particular businesses work with merchants who collectively advertise and produce “packs” of postcard-sized advertisements (usually about 30 or so) that are mailed out to select households. Mailings usually occur quarterly and merchants “sign up” to be included in the mass-mailing. However, the postcard advertisements are non-personalized, with non-variable data, i.e., each household receives the same pack, and are easily and often thrown away before the consumer uses them or even looks at them. In addition, there is currently no way of knowing where the coupons terminate or who uses them. This lack of information fails to provide the advertiser with any feedback on the effectiveness of the advertising.

Another multi-merchant product is referred to as a “coupon pack.” With coupon packs, companies send out cooperative mailings containing coupons offering discounts or other incentives to potential consumers. Usually they are addressed to “Household” rather than a specific consumer. Regardless, the data inside the coupon packs is non-personalized, non-variable, and non-traceable to any particular consumer. Again, this lack of information fails to provide the advertiser with any feedback on the effectiveness of the advertising.

Gift cards are becoming more prevalent in stores, restaurants, service establishments, and others as a convenient revenue generator. Gift cards are basically pre-paid credit cards that can be used, once funded, as a debit card at the retail establishment. More specifically, the store or other entity issuing the card associates an account with the card. A sale is made as soon as the giver deposits money into the account linked to the card. The card recipient can then return to the store and select merchandise, which is then subtracted from the card's balance. Advantageously to the store, one of two scenarios usually takes place: either the recipient makes a purchase that exceeds the pre-paid amount of the card, resulting in an even larger sale for the store, or the recipient makes a smaller purchase than the value of the card, leaving a balance in the account, which is then never used by the recipient and, after a predetermined period of time, becomes a donation to the store. Even if the exact amount on the card is used, all scenarios are beneficial to the establishment.

Current gift cards have limited or no trackability. Most gift cards are tracked based on redemption only, so retailers and advertisers have no concept of consumer acceptance until several days or weeks after the gift card is redeemed. The advertiser obtains no information on consumers who intend to redeem the offer, but never get around to it.

Gift cards are not sent cooperatively as to offer a consumer a variety of offers.

Currently there is not a system in place for any cooperative program that allows a consumer one step to react to on a collaborative level with all offers and/or retailers in the program.

Gift cards are not being shared virally, using the Internet to allow friends and family members to download printable gift cards either through email or “social” networks such as FACEBOOK® and MYSPACE®. Some types of offers or businesses are advertised or shared through these social networks, but they are simply links provided on a user's page that are clickable by others. Once the click takes place, the clicking user can view more details of the offer but the offeror will have no information as to who the user is, who's social network page the user came from, or how the owner of the social network page came to provide the link that the user clicked on. In other words, no tracking takes place.

Currently merchants' gift cards are available at the merchant locations, including on-line locations, or from third-party retailers. Some merchants fund the cards themselves and give the cards as gifts to customers as a reward or incentive to return to the store. Gift cards could include prepaid debit cards or discount cards and often include a magnetic strip or an access code—either of which can be used to redeem its value at the store, over the phone, or on-line. However, current gift card distribution is limited to requiring a party to either actively navigate to a merchant to purchase the card, or for the party to have an existing relationship with the merchant and for the merchant to generously or proactively convey a card to the party. Unfortunately, there is no ability for the merchant to rely on the former or for the party to rely on the later. In addition, currently all forms of marketing do not measure purchase intent.

Therefore, a need exists to overcome the problems with the prior art as discussed above.

### SUMMARY OF THE INVENTION

The present invention, according to an embodiment, provides a marketing product (defined as, but not limited to, materials used for marketing, including direct mail, magazines, magazine inserts, newspaper inserts, and leave-behind materials) that includes a plurality of gift cards corresponding to offers provided by multiple merchants. In one embodiment, the cards are provided with codes that are traceable to the address to which the cards were mailed. A user can call a phone number associated with the cards or navigate, via web browser, to a web page associated with the cards and register/activate all the cards at once. When the user activates the cards, the entity receiving the activation also receives information associated with the consumer.

With the foregoing and other objects in view, there is provided, in accordance with the invention, a method for stimulating commerce includes the steps of presenting an offer to a consumer, receiving from the consumer an identifier of a selected mode for sharing the offer, and dynamically generating a unique URL, where the unique URL includes an identifier of the consumer, the identifier of the selected mode for sharing the offer, and an identifier of the offer. The method includes the further steps of placing the dynamically-generated URL in the selected mode for sharing the offer, the dynamically-generated URL being selectable by a user, and electronically sharing the offer via the selected mode.

In accordance with another feature of the invention, the selected mode can be a social network, a text message, an instant message, and/or an email.

In accordance with a further feature of the invention, the method includes the steps of receiving, via an electronic network, an indication of a selection of the dynamically-generated URL by the user and receiving the identifier of the offer as well as an identifier of the user, the identifier of the consumer, and/or an identifier of a social network.

In accordance with an added feature of the invention, the method also includes the steps of receiving from the user, via the electronic network, an identifier of a new mode for sharing the offer, dynamically generating a second unique URL, the second unique URL including the identifier of the offer as well as an identifier of the user, the identifier of the consumer, and/or the identifier of the new mode for sharing the offer. The method also includes the step of placing the second dynamically-generated unique URL on the new mode for sharing the offer, the second dynamically-generated URL being selectable by a second user.

In accordance with an additional feature of the invention, the method includes the steps of receiving from the user an identifier of the selected mode for sharing the offer and dynamically generating a second unique URL, the second unique URL including the identifier of the offer and an identifier of the user, the identifier of the consumer, and/or the identifier of the selected mode for sharing the offer. The method further includes the step of placing the second dynamically-generated unique URL on the selected mode for sharing the offer, the second dynamically-generated URL being selectable by a second user.

In accordance with yet another feature of the invention, the method includes the steps of receiving at least one activation code from the consumer and communicating an activation instruction to at least one merchant associated with the offer, in response to receiving from the consumer the identifier of the selected mode for sharing the offer.

In accordance with yet a further feature of the invention, the receiving and dynamically generating steps are performed at a central server communicatively coupled to a communication network

With the objects of the invention in view, there is also provided an economic stimulus system that includes a central server communicatively coupled to a communication network and operable to compose an offer for a consumer and a network connection communicatively coupling the consumer to the central server. The network is able to communicate the offer from the central server to the consumer and communicate from the consumer to the central server an identifier of a selected mode for sharing the offer. The central server is further able to dynamically generate a unique URL, the unique URL including an identifier of the consumer, the identifier of the selected mode for sharing the offer, and an identifier of the offer and is able to place the dynamically-generated URL in the selected mode for sharing the offer, the dynamically-generated URL being selectable by a user and electronically share the offer via the selected mode.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention. These schematic illustrations are not true to scale.

FIG. 1 is a plan view from the front of a gift-card sheet according to an exemplary embodiment of the present invention.

FIG. 2 is a plan view from the rear of the gift-card of FIG. 1.

FIG. 3 is a process flow diagram of a method for performing an exemplary embodiment of the present invention.

FIG. 4 is a diagrammatic illustration of a network of data processing systems according to an exemplary embodiment of the present invention.

FIG. 5 is a block circuit diagram of a data processing system according to an exemplary embodiment of the present invention.

FIGS. 6 and 7 are exemplary representations of a self-mailer card sheet according to an exemplary embodiment of the present invention.

FIG. 8 is a timeline illustrating the steps of standard direct mail in comparison to the steps of an exemplary embodiment of the present invention.

FIG. 9 is a process flow chart illustrating exemplary steps that can be used by advertisers and companies utilizing an exemplary embodiment of the present invention.

FIG. 10 is a process flow chart illustrating exemplary steps that a consumer would use to activate their cards and possible disseminate through email or internet social applications according to an exemplary embodiment of the present invention.

FIGS. 11-13 are focused sub-steps of the process flow chart of FIG. 10.

FIGS. 14 and 15 are an exemplary representation of a self-mailer card sheet according to an exemplary embodiment of the present invention.

FIGS. 16 and 17 are exemplary snap shots of reports showing illustrating campaign results.

FIG. 18 is a process flow chart illustrating exemplary steps that can be used by consumers to share offers according to an exemplary embodiment of the present invention.

FIG. 19 is a process flow chart illustrating exemplary steps that can be used by second consumer to share offers previously shared by a first consumer according to an exemplary embodiment of the present invention

### DETAILED DESCRIPTION

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

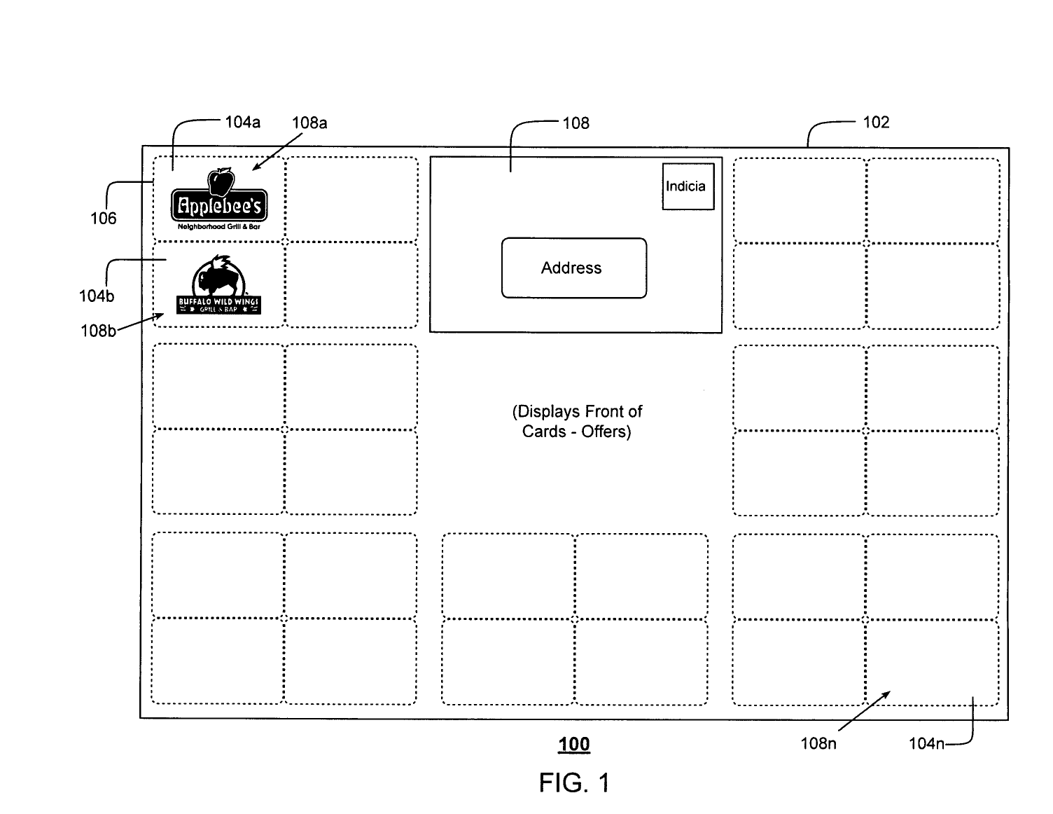

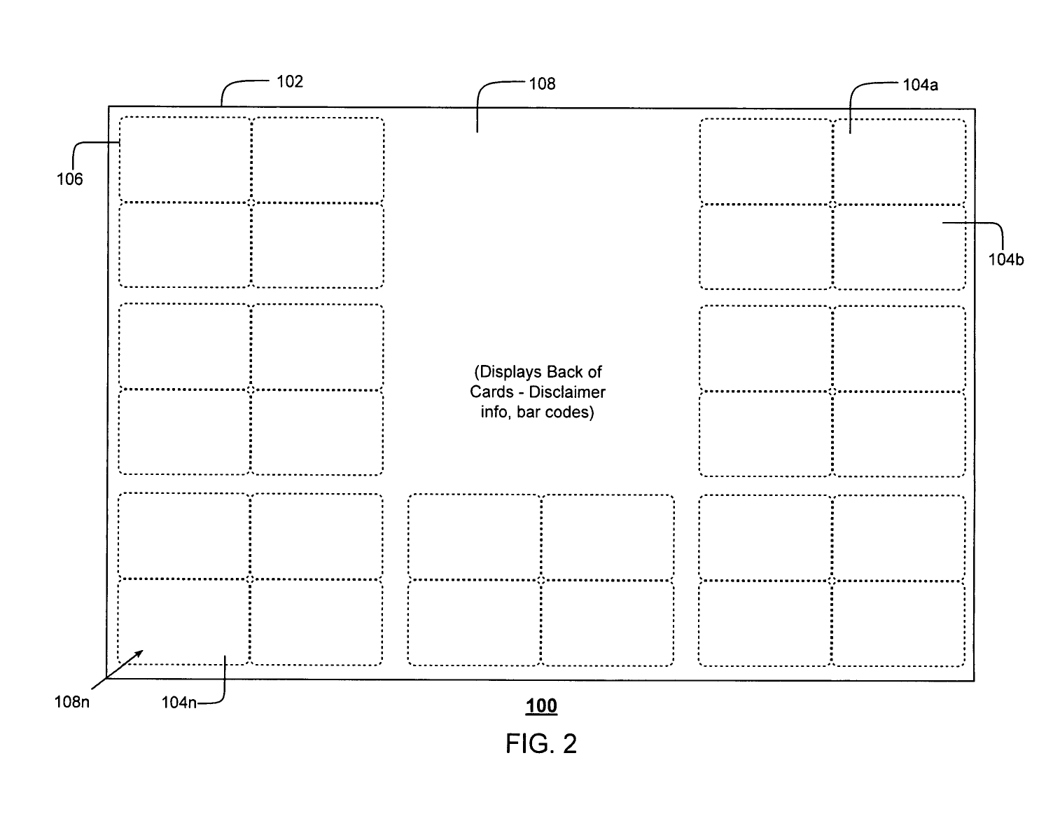

The present invention advantageously provides a personalized and trackable gift card/coupon/offer postage assembly useful for direct-mail marketing from multiple businesses to consumers. In one embodiment, the invention, as shown in FIGS. 1 and 2, includes a gift-card assembly that can hold any amount (e.g., as many as, but not limited to, 200) of different gift cards that are each customized to individual consumers through variable data placed on the gift cards or associated with the gift cards.

Referring now to FIG. 1, a card assembly 100 is shown. The assembly 100, according to one embodiment, is a sheet 102 forming a plurality of cards 104a-n. The term “assembly,” as used herein, is intended to indicate any form of mailer, which can include one or more sheets of paper, plastic, cardboard, separate or together or other materials capable of being printed on and mailed to a recipient. In the embodiment of FIG. 1, the cards 104a-n can be separated from the sheet 102 by tearing along perforated edges 106 (only one of which is shown in FIGS. 1 and 2 with a dotted line). In another embodiment, which may be separate or combined with the first embodiment, the cards 104a-n are attached to the sheet 102 by an adhesive, such as a backing on the cards 104a-n or an adhesive front on the sheet 102 that adheres to the cards 104a-n, for example. The cards 104a-n can be laminated, plastic, coated, or non-coated. Advantageously, as will be explained below, the card assembly 100, including, and in some cases specifically, the plurality of cards 104a-n, is an instrument that is fully trackable back to each retailer/advertiser. Advantageously, a sender can positively identify a recipient of one or more of the cards 104a-n.

As is shown in FIG. 1, each of the cards 104a-n is provided with a graphic 108a-n that is associated with, and, in most cases, unique to the sponsoring merchant. For example, the first card on the sheet 104a displays the trademarked logo 108a of the restaurant at which the card can be used. This particular exemplary card provides no other indication of the value of the card. In other words, there is no indicator on the card 104a of whether this card provides a discount from the normal prices or whether money has been or can be placed in an account associated with this card. However, the card could be printed with information about the type of discount or value of the card. For instance, card 104n has a graphic 108n that shows the exact value of the card right on the card 104n itself. Merchants' cards can take the form of any offered discounts and cash value, including prepaid and/or (re)loadable. Therefore, the present invention includes at least two main embodiments: (1) a coupon assembly; and (2) a postage assembly. The coupon assembly includes any form of one or more coupons that are readable by a recipient. A postage assembly includes one or more offers, which can be coupons and can also include redeemable gift cards or other offers. The coupon and postage assemblies can be physical or virtual, i.e., graphical and transmitted via the internet, for example.

FIG. 2 shows an exemplary backside view of the card assembly 100. This backside is most likely accurate for the embodiment with perforations 106, where each card 104a-n is separable from the sheet 102. In an embodiment where each card 104a-n is individually adhered to the sheet 102, through adhesive, for instance, each card 104a-n may still resemble the cards 104a-n shown in FIG. 2. The back sides of the cards can contain details of the type, intended use of, value of, limitations of, or other details and aspects of the cards 104a-n, the stores they are associated with, or the offers they present, including bar codes integrated into each that could essentially be tied to the retailers point of sale (POS) system.

In the particular embodiment shown in FIGS. 1 and 2, the card assemblies 100 include a central card 108 that is larger than the surrounding cards 104a-n. The central card 108, due to its size, tends to grab the initial attention of the viewer when first viewing the assembly 100. For this reason, the central card 108 may be a position of special interest to particular merchants. In one embodiment, the card assembly 100 will be populated with cards 104a-n and 108 that correspond to businesses that are all within the same location. For instance, all or several merchants in a single structure, for example, a shopping mall or other building, or closely organized buildings, will be featured in the single assembly 100. The central card 108, could be an advertisement for the mall itself or for a flagship store of the mall. In another exemplary embodiment, the card assembly 100 can be populated with cards 104a-n and 108 that correspond to businesses that are all within a close geographical location, e.g., within the same city or town or not close geographically at all.

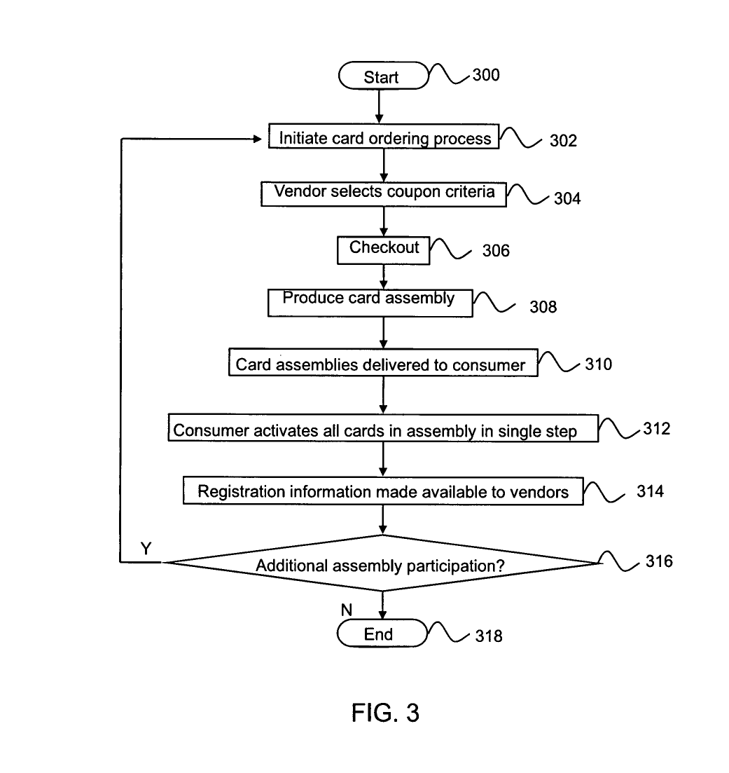

Looking now to FIG. 3, a process flow diagram is shown that illustrates exemplary steps for creating and using the present invention according to an embodiment. The flow starts at step 300 and moves directly to step 302, where a merchant or merchant initiates a card ordering process. The ordering process can be performed in several ways. Of course, a first way is for the merchant to physically communicate to someone with access to a card-making element of the present invention what it is they would like to order. Today, face-to-face communication is becoming the exception but is it envisioned nonetheless. Therefore, the present invention provides a second method of communicating the merchant's needs, which is through on-line communication, for example, the Internet.

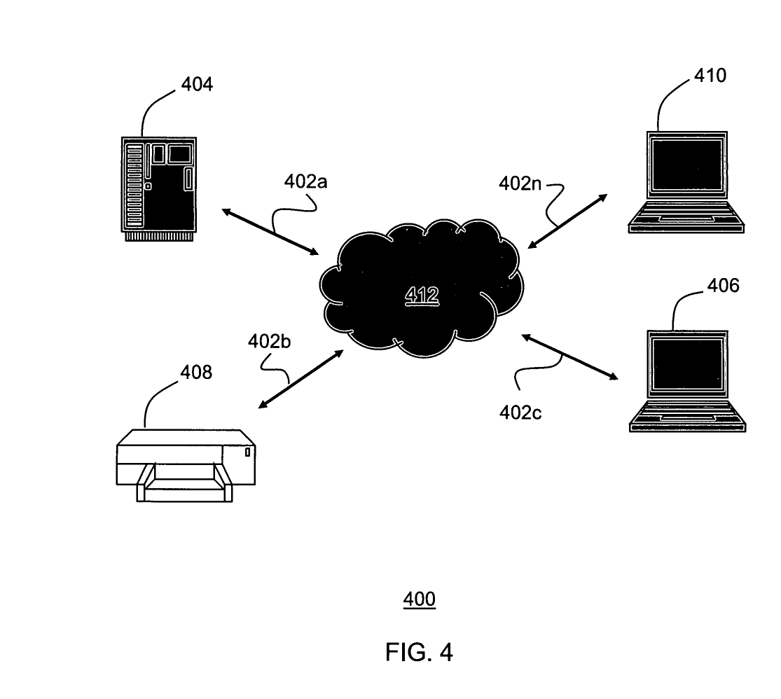

Moving briefly from FIG. 3 and referring now to FIG. 4, there is depicted a representation of a network of data processing systems in which the present invention may be implemented. The network 400 includes connections 402a-n, which are the medium used to provide communications links between various devices and computers connected together within the network 400. The connections 402a-n may be wired or wireless connections. A few exemplary wired connections are cable, phone line, Internet, LAN, and fiber optic. Exemplary wireless connections include radio frequency (RF) transmissions. Many other wired and wireless connections are known in the art and can be used with the present invention. In the depicted example, a merchant 410 is connected to or has at least temporary access to at least one other element of the network 400. The merchant 410 may be, for example, a personal computer or network computer or any other device that has electronic communication capabilities and is able to communicate with or over the network 400. In addition, a proprietary server 404 is also connected to the network 400.

Network 400 may include additional servers, merchants, and other devices and entities not shown. In the depicted example, merchant 410 communicates with the proprietary server 404 and, as will be explained in detail below, proprietary server 404 provides data, such as listing card assembly 100 choices offered by the present invention to the merchant 410. The merchant 410 is also able to communicate over the network 400 with additional servers, consumers, and other devices and entities. Any of the depicted network entities, in addition to communication with each other over the network 400, are, in some embodiments, also able to communication in a peer-to-peer communication using wired or wireless links.

A consumer 406 is also connected to the network 400 and is able to receive communications from the proprietary server 404, according to certain embodiments of the present invention that will be described below. The consumer can engage in one-way or two-way communication with the sever 404 and in some cases with the merchant 410.

In the depicted example, the connecting element 412 of the network 400 can be the Internet, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems that route data and messages. Of course, network 400 also may be implemented as a number of different types of networks, such as for example, an intranet, a local area network (LAN), or a wide area network (WAN). FIG. 4 is intended as an example, and not as an architectural limitation for the present invention.

Server/Computer

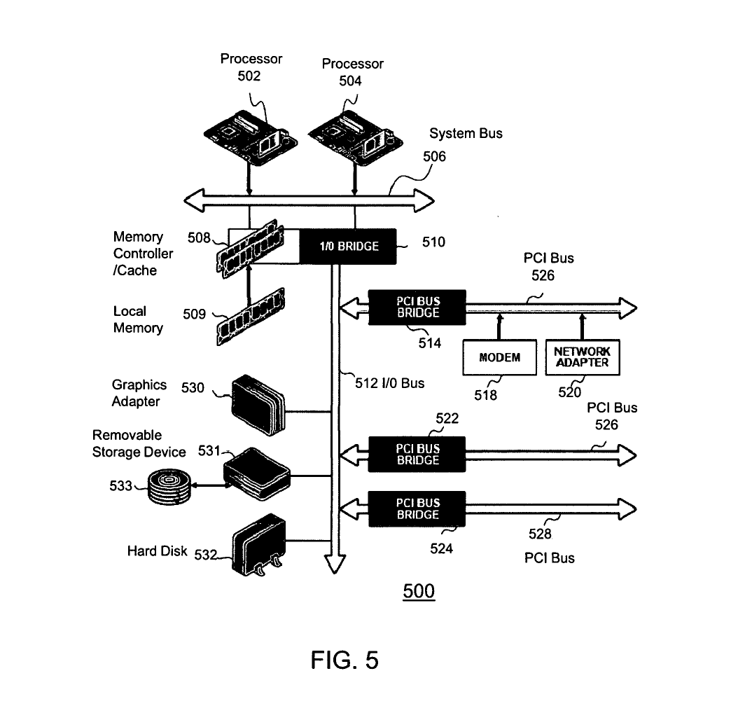

Referring to FIG. 5, a block diagram of a data processing system that may be implemented as a server, such as server 404, or implemented as a personal computer, such as merchant computer 410 or consumer computer 406 in FIG. 4, is depicted in accordance with one embodiment of the present invention. Data processing system 500 may be a symmetric multiprocessor (SMP) system including a plurality of processors 502 and 504 connected to system bus 506. Alternatively, a single processor system may be employed. Also, connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted. The processor 502 or 504 in conjunction with memory controller 508 controls what data is stored in memory 509. The processor 502 and/or 504 and memory controller 508 can serve as a data counter for counting the rate of data flow to the memory 509 or from the memory 509 and can also count the total volume of data accessed to or from the memory 509. The processor 502 or 504 can also work in conjunction with any other memory device or storage location.

Peripheral component interconnect (PCI) bus bridge 514 connected to I/O bus 512 provides an interface to PCI local bus 516. A number of modems may be connected to PCI bus 516. Typical PCI bus implementations will support four PCI expansion slots or add-in connectors. Communications links to network computers in FIG. 1 may be provided through modem 518 and network adapter 520 connected to PCI local bus 516 through add-in boards.

Additional PCI bus bridges 522 and 524 provide interfaces for additional PCI buses 526 and 528, from which additional modems or network adapters may be supported. In this manner, data processing system 500 allows connections to multiple network computers. A graphics adapter 530 and hard disk 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

The merchant server functions are explained in detail below and can be embodied in a computer program. Computer programs (also called computer control logic) are stored in memory such as main memory 509, removable storage drive 531, removable media 533, hard disk 532, and signals. Computer programs may also be received via communications interface 516. Such computer programs, when executed, enable the computer system to perform the features of the present invention as discussed herein. In particular, the computer programs, when executed, enable the processor 502 and/or 504 to perform the features of the ODS agent 114.

In this document, the terms “computer program medium,” “computer usable medium,” and “computer readable medium” are used to generally refer to media such as main memory 509, removable storage drive 531, removable media 533, hard disk 532, and signals. These computer program products are measures for providing software to the computer system. The computer readable medium allows the computer system to read data, instructions, messages, or message packets, and other computer readable information from the computer readable medium. The computer readable medium, for example, may include non-volatile memory, such as floppy, ROM, flash memory, disk drive memory, CD-ROM, DVD-R, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allows a computer to read such computer readable information.

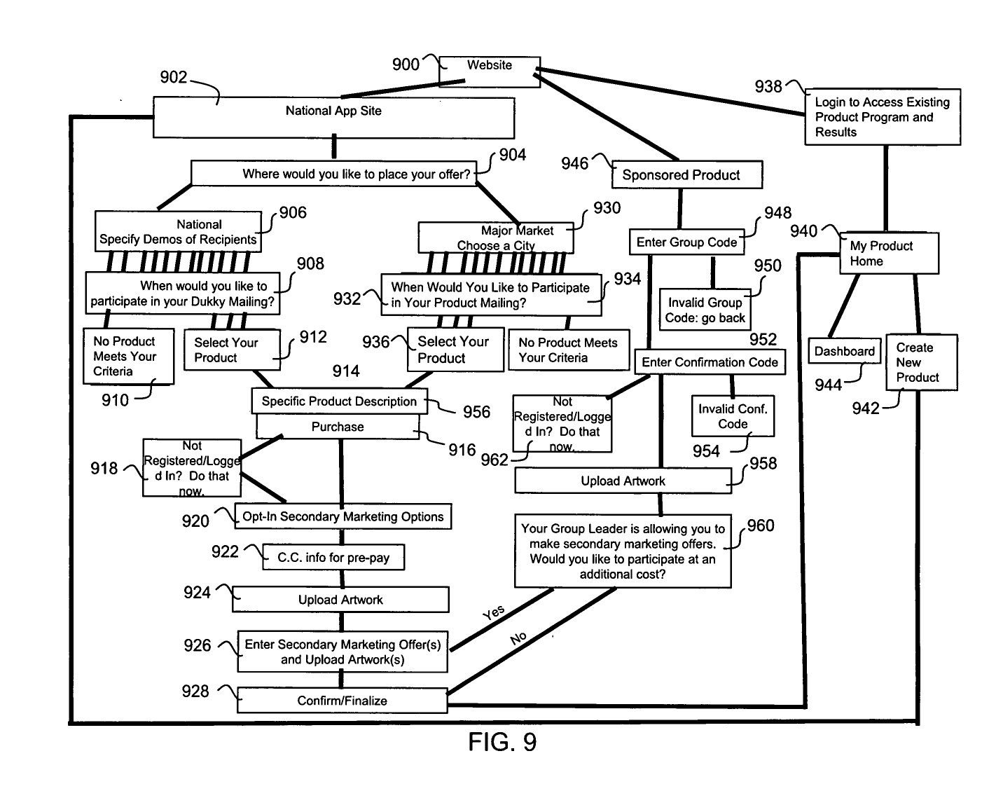

Returning now to FIG. 3, the flow moves to step 304 where a merchant 410 engaging in the ordering process (in this example, by accessing a website) selects coupon criteria for inclusion on a coupon card that will be part of a postage assembly sheet 100. “Criteria,” as used herein, means any attribute of the offer that will be associated with the card, such as discount amount and look of the card. Based on their industry or needs, the merchant is able to select its target demographic, frequency of mailing and/or printing, placement on the layout of the piece, and the customization of their card, i.e., artwork, text, card value, etc. Merchants can also be given the option of purchasing space on the postage assembly sheet for future scheduled printing and mailing and/or electronic communication or they may purchase a single instance. Providing a website where merchants can remotely make all necessary selections is greatly advantageous as the server 404 is able to quickly present a graphic layout of each card and its location on the particular assembly 100 to the merchant. This process is described in detail below and shown in FIG. 9.

The merchant will be able to interact with the site to upload their artwork, review their target market information, drag-and-drop their card to their desired location on the layout of the mailer 100, and/or many other options. In addition, the merchant will know if its selected card location is already reserved by another merchant as the location will be graphically noted and, in one exemplary embodiment, drag-and-drop will not function on a reserved location. Once the order is complete, the flow moves to step 306 where an on-line shopping cart/checkout will be available to finalize the merchant's order.

Next, in step 308, the card assemblies 100 are physically produced. The production is performed, according to one embodiment of the present invention, by printing on a web press 408, shown representatively in FIG. 4, capable of producing fully variable data across each sheet 102, i.e., each card 104a-n can be personalized for multiple merchants' offers and sent directly to each one of a selected group of consumers. One exemplary printer 408 is an iGEN™ printer manufactured by XEROX or KODAK VERSAMARK.

The card assembly 100 can be formed as a self-mailer, a mailer within an envelope, an insert in a periodical or a leave-behind, or other forms. Each and every one of the cards 104a-n in the assembly 100 can be customized for a single targeted customer. For instance, card intended for recipients below age 18 may have entirely different artwork, could be for different stores, or provide different offers than would a card for someone over 45 years of age. Data for customization can be obtained from step 304, the details thereof will be reserved for the explanation of this step below.

In the same or a separate step, the assembly 100 can be folded and die-cut into a multitude of custom shapes and sizes. As one practical example, each sheet 102 can be capable of carrying as many as, but not limited to 200 cards. The card assembly 100 is advantageous because a merchant can get 10 to 20 times more impressions than with other mailers because of the co-operative nature of the mailing. In addition, each card can be affixed with a magnetic strip, bar code, or printed card-specific code or label.

In step 310, the card assemblies 100 are delivered to the consumer. This delivery can be by regular U.S. mail or by any other delivery measures. In some embodiments, the physical printing step, step 308, is skipped and delivery is via electronic measures, such as email or social networks (e.g., FACEBOOK®, IPOWER®, or others). In this embodiment, the consumer receives the electronic transmission of the assembly 100 and performs the printing at the consumer location. The consumer can print the entire assembly 100 or select individual ones of the plurality of card choices 104a-n for printing. Regardless of the order of steps 308 and 310 for consumer reception of the assembly 100, once the consumer receives the assembly 100, the consumer performs a registration step in step 312.

In one embodiment of the present invention, each assembly 100 has a specific card-activation sequence, which can be performed in step 312 by phone, on-line login, in person, or any other method. Instructions for the activation sequence can be printed on the assembly 100 and, once followed by the targeted consumer, will activate all of the cards on the sheet. All that may be needed is the entry of a single code. That is, all of the cards can advantageously be activated in just a single step. For example, the assembly 100 may contain a phone number or website that the consumer can call or log into to register. Advantageously, when registering, the activating consumer will simply enter a consumer identifier. This identifier identifies who received the assembly 100 and further identifies that this consumer is potentially a good lead for future offers. For example, once connected, the consumer can be prompted to enter an identification number listed on the sheet 102. The identification number is linked to the addressee to whom the assembly 100 was mailed to, who is then identified as the registrant. Alternatively, the service at the number the consumer dials for registration of the assembly 100 or any of the cards 104 can prompt the consumer for identifying information, such as name, address, email address, and other related information of the consumer. Using, for instance, Interactive Voice Response (IVR) technology, which recognizes a user's speech, the user could be prompted to answer a series of questions containing, but not limited to, the intent to purchase the goods advertised. It should be noted that, in practice, there may be no actual need to activate the cards before using them. The cards may provide an indication of being in an inactivated state, but, regardless of activation steps on the part of the recipient, will be redeemable by the receiving party.

As an additional alternative, the registering user may be given the opportunity to activate selective ones of the plurality of cards 104a-n for use as gift cards without activating others. For example, each one of the cards 104a-n could correspond to a goods or service provider. The registering user would then be able to, for instance, call a number or visit a website listed on a particular one of the cards 104a-n and add money to an account associated with the selected card. The card can then be used at an establishment that is able to access the account and retrieve funds sufficient to compensate for the purchase made by the user of the card, whether the user is the registering user or someone who later receives the card.

As one particular example of the invention, a recipient of the card assembly 100 may have a birthday party to attend. Prior to attending the party, the gift-giver can select and remove from the sheet 102 a card 104 that is well-suited for the person who is having the birthday. For instance, if the second person likes electronics, the first person can select a card for an electronics store. The gift giver then follows registration instructions on the card for activation. In this example, the recipient of the assembly 100 calls in or logs in via the Internet and provides his or her personal bank account or credit card information so that a balance can be added to the card. The activated card then makes a great gift, as the person receiving the gift can purchase whatever they desire at the associated store without the giver having to worry about matching the receiver's particular tastes. In addition to the advantage that the giver never had to go shopping, the giver is assured that his account information is never revealed to the person receiving the gift. The store enjoys a further advantage as they realize an instant sale when the gift giver adds the funds, even though the goods may not be picked up for quite some time. For this reason, it is anticipated that the stores will be very cooperative in getting the card sheets mailed to perspective consumer's addresses.

Once registration is complete, the flow moves to step 314, where the registration information is made available to one or more merchants advertising on or through the assembly 100. In one embodiment, each merchant is provided with their own “dashboard,” which allows them to track the response of their target market, including names, addresses, age group, email addresses, phone numbers, zip codes, and more. A dashboard is a software program that is typically displayed in a portion of a computer screen and provides visual information to a viewer. The dashboard can be running on a local machine and updated over a network or it can be entirely web-based, where the merchant can log in via the Internet and see real-time information registration information. Based on prompted inputs, merchants can also have the option of obtaining product preferences, lifestyle information, personal data, and any other one-on-one useful consumer information.

Based on individual consumer responses from the first assembly 100, the merchants will be able to purchase subsequent follow-up mailings to particular households. Step 316 provides a choice to the merchant to participate in a second card assembly 100. If the merchant chooses yes, the flow moves back up to step 302 and, for this second order, the feedback from the first can be used. If the merchant chooses no, the flow moves to step 318 and ends.

In addition to using the feedback to place additional orders, consumers can be offered the option to provide their cellular phone numbers and/or email addresses in order to receive future offers from retailers via text messaging and emails. This opens up new and different media streams for reaching potential consumers. Based on the consumer responses to the cards 104a-n, it is possible to acquire an extensive and valuable database of consumer information. This information can be marketed and resold as sales leads to prospective businesses.

One of the many variations of the gift card sheets is based on certain “themes” of life events. Consumers, when registering, or actively ordering cards 104a-n, can order cards 104a-n for use for themselves or as gifts for others. The present invention makes customized and personalized gift card packages available for events including, but not limited to, weddings, birthdays, graduations, proms, sporting events, vacations and excursions, sports teams, hunting/fishing, automotive, dining/beverage, and many others. For example, an Orlando-vacation-gift-card sheet could include gift cards applicable to DISNEY® theme parks, SEA WORLD® water parks, hotel stays, local restaurants, shuttle services, airfare, etc.

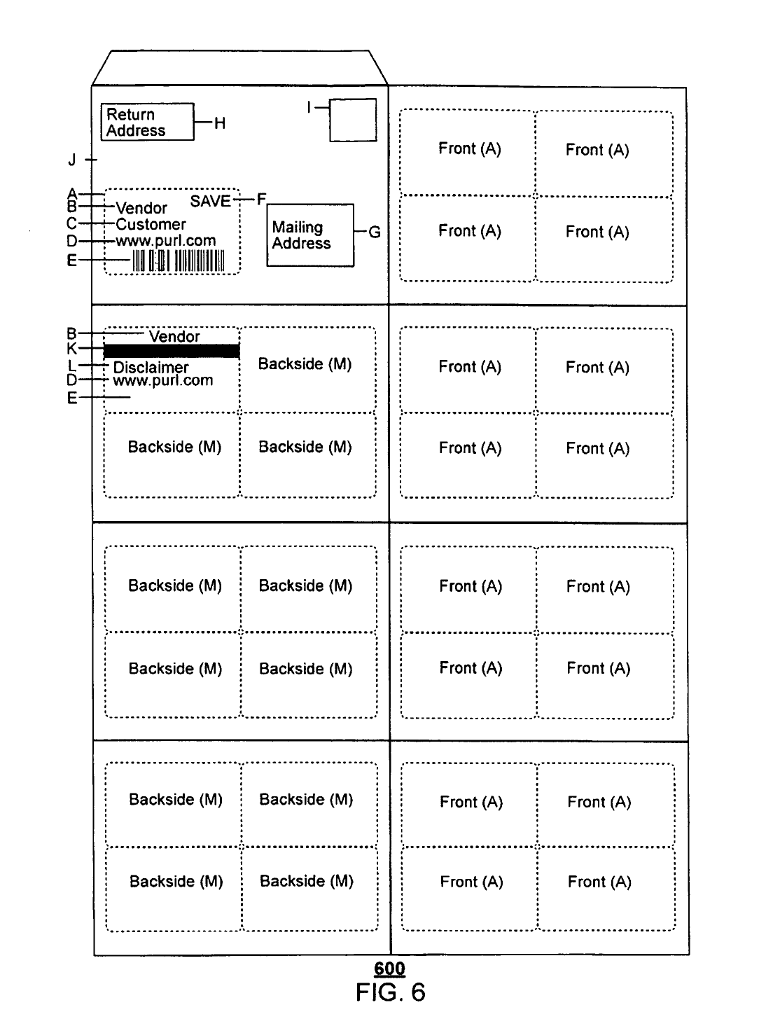

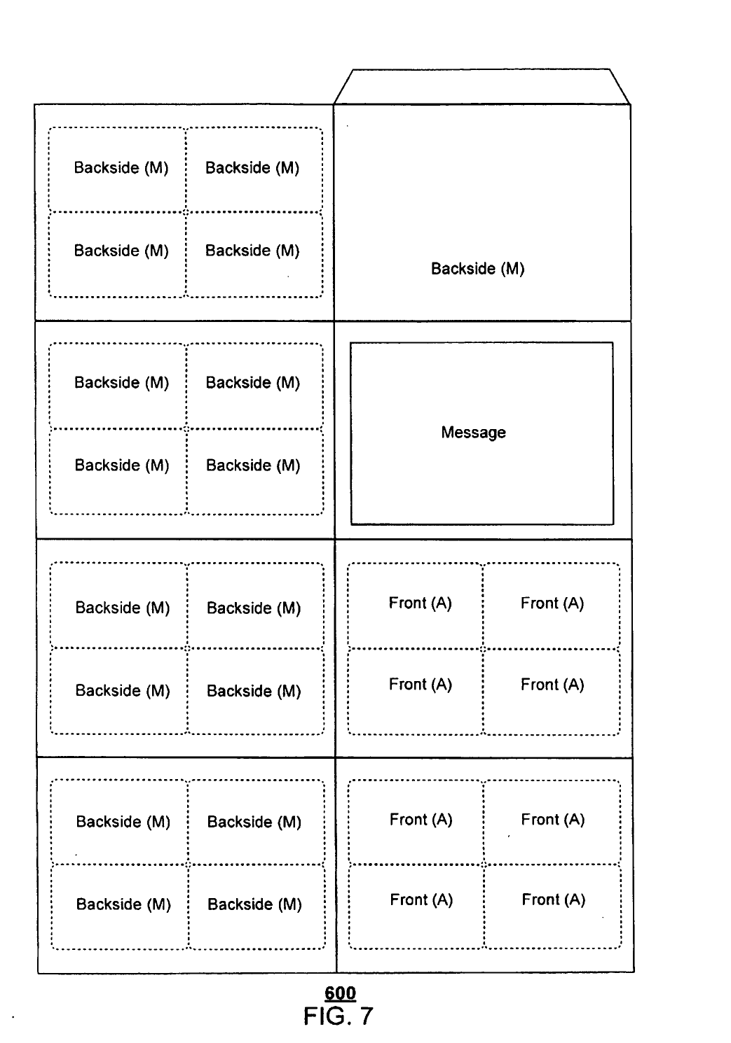

FIGS. 6 and 7 provide an example of a self-mailer card sheet 600, according to an embodiment of the present invention, with completely variable data A-M. The following key defines the letter-designated variable data components A-M of FIGS. 6 and 7.
A) Offer card front—current layout size of 3.25″×2″. The offer card size can vary from as tall or wide a 56″ and as small as ¼″ and doesn't need to keep the same aspect ratio. This layout shows a perforated edge application, but the offer card can be a free standing card, a kiss cut (peel out card) with or without adhesive backing, laminated or with no coating.
B) Represents the company or companies being advertised. One company to 200 companies can be represented with a offer card on this medium.
C) Represents the “variable component.” Each offer card can be labeled with or without the variable component, putting specific data that pertains directly to the consumer including Name, Address, shopping habits, or any other relevant information that might have been obtained legally and permissible by the law.
D) Website tie-ins available on every offer card. There is an option to have a website URL that is personalized to the specific customer using variable data.
E) Bar Code application for easy tracking and redemption of offer card on the company level. This is optional on the offer card.
F) Optional hook for every merchant. This hook can be static and placement of hook is can be anywhere on the offer card.
G) Address Panel: This example is built as a self-mailer. The offer card can be used in other applications, including stuffed mail, magazine inserts, newspaper inserts, leave behind (self encompassing) magazines, promotional materials, etc.
H) Return address (optional, used here for self mailer application)
I) Indicia or Stamp area (optional, used here for self-mailer application)
J) Size of sample: The offer card mailer is fully scalable to, but not limited to, 56″×40″ with many variations of folds. The example show represents a 17.25″×25.5″ page, folded down to a mailing size of 9″×6″. The application could be represented in a magazine form with an unlimited number of pages encompassing an unlimited number of offer cards.
K) Magnetic Strip: The offer card may or may not have a magnetic strip application for transaction and tracking purposes.
L) Used to disclose the advertised savings and how it is awarded legally.
M) Back of card: this mailer example shows the back of the card is displayed on the mailer. Some applications of the offer card have the back of the card “stuck” to the actual mailer and not used with perforated edges.

Companies currently exist, e.g., magazines, newspapers, etc., who have access to both their advertisers information and their customers information, including email addresses. For those companies, the present invention could be applied in a completely electronic format. Specifically, the companies could build out an email or some other electronic messaging that goes directly to the targeted consumer, the messaging offering an on-line capability to distribute electronic gift cards, to activate their cards, to input their promotional codes, to go directly to the advertisers website, and other similar transmissions. For example, a company that publishes magazines could create an entirely electronic gift card assembly, possibly modeled after the one shown in FIG. 1. The company could then send the electronic assembly in an email directly to targeted customers or direct them via emailed instructions to a website that has a layout of retailers' cards in an electronic format. A customer can then click on the retailer's card and, in response, be prompted to enter an activation code. Several options are then available. The step of entering the code can bring the customer directly to the retailer's website with an amount of money in credit or a discount amount applied to any sale. Entering the code can initiate the provision of a file that the customer can print, the printed product having a scanable bar code or any other discount/coupon amount.

As an additional revenue stream, data associated with the activating consumer can be stored in memory 509 and later used or sold to any third party.

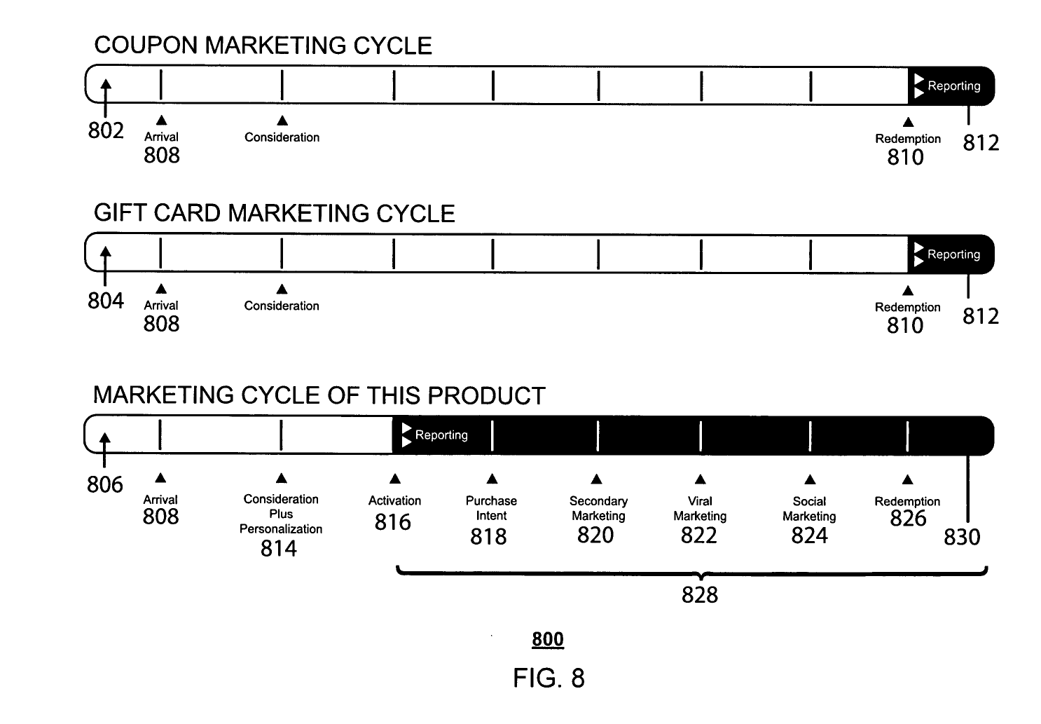

FIG. 8 provides a visual depiction of the exemplary features of the present invention in comparison to the prior art method of providing coupons and gift cards. Specifically, timelines 802 and 804 show the process of conveying coupons (timeline 802) or gift cards (timeline 804) to a consumer. Once either arrives in the mailbox 808 of the recipient, there is no reporting 812 or feedback available to the merchant until or after the time of redemption 810.

In stark contrast to the prior art, the present invention, as shown in timeline 806 of FIG. 8, provides multiple points of feedback and opportunities for providing secondary marketing, viral marketing, social networking, and others.

Specifically, similar to timelines 802 and 804, in timeline 806, a mailer is delivered to mailbox 808 or otherwise transferred to a consumer. The inventive mailer 814 not only includes consideration, i.e., the offer, but also includes personalization. Once the consumer activates 816 the mailer, reporting 830 to the merchant can immediately begin. As is graphically shown in FIG. 8, because of this instant reporting, a plurality of steps are now available to the merchant that are otherwise non-existent in the prior art.

In step 818, the consumer is invited to provide purchase intent. Purchase intent, according to one embodiment, is provided by a consumer's selection of one or more brands, stores, types of items, etc. during the activation process. For instance, a consumer can select a list of stores at which he/she envisions shopping. The consumer can be motivated to select these stores by being made to think that his/her card(s) will only be activated for those selected places. However, it is envisioned that the card(s) will be active, i.e., actually work, at the stores regardless of whether or not the consumer goes through the activation process. However, now that that process has been initiated and the consumer has completed step 816 or 818, the information 828 is reported 830. This information 828 can be used for creating secondary marketing 820, such as follow-up advertisements from the selected stores, viral marketing 822, such as email, text messaging, instant messaging, and social networking 824, such as FACEBOOK®, MYSPACE®, and others, where users can control the content of personal web pages. A practical example of the present invention applied to social networking 824 technology would be where a consumer is able to post the offering presented by the mailer to his/her personal page for others to see and take advantage of the benefits. By posting the offer, the consumer is endorsing the offer to his/her friends and, in at least one embodiment of the present invention, could be given a financial incentive for doing so. The offer is finally redeemed in step 826 and reported in step 830.

FIG. 9 is a flow chart providing exemplary steps of for utilizing the inventive registration process for providing offers on mailers. The process begins at step 900 where a merchant navigates to the target website provided by the entity facilitating the present invention. Again, the term “merchant,” as used herein, indicates any person or entity that desires to have information placed on a mailer. If the merchant wishes to start a new offer, the flow moves to step 902 where a new application page is presented to the merchant. In step 904, the merchant selects the locations(s) where the offer should be distributed. If the selection is national, the merchant is asked, in step 906, for the demographics desired of the recipients of the offer. Next, in step 908, the merchant is asked for a time definition for the offer. If no currently-scheduled mailer meets this criteria, the merchant will be informed, in step 910, that no mailer meets the merchant's criteria. If a scheduled mailer meets the merchant's criteria, the merchant, in step 912, is informed of this fact and, in the same step 912, is invited to select a particular mailer if more than one is available. In step 914, the merchant specifies the details of the offer and, in step 916, selects “purchase” to purchase the mailer/offer.

To complete the purchase, the merchant logs in to the website in step 918. As an additional feature, the merchant can now choose to set up secondary marketing in step 920 as was shown in step 820 of FIG. 8. Secondary marketing can be any follow-up offer subsequent to the first and can be in the form of any type of marketing (e.g., mail, email, phone solicitation, etc). It can be an offer that is automatically included with the next scheduled mailer, can be an offer that is quickly generated and mailed upon receiving registration information from a consumer, both, or many others. In subsequent steps, payment information is entered 922, artwork is uploaded 924, secondary marketing offers and artwork is uploaded 926, and the offer/mailer is confirmed/analyzed 928.

Returning to step 904, if, instead of selecting national (step 902), the merchant chooses to direct the offer to a particular city, the flow moves to step 930 where the city(ies) is(are) selected and, in step 932, a time of offer is selected. If no scheduled mailer meets this criteria, the merchant will be informed in step 934 that no mailer meets the merchant's criteria. If a scheduled mailer meets the merchant's criteria, the merchant, in step 936, is informed of this fact and, in the same step, is invited to select a particular mailer if more than one is available. In step 914, the merchant specifies the details of the offer and, in step 916, selects “purchase” to purchase the mailer/offer. The flow then continues as described above for steps 918 to 928.

If, in step 900, the merchant chooses to log in to his/her account, the flow moves to step 938, where the merchant logs in to an existing mailer/offer or accesses results from an existing mailer/offer. After logging in, in step 938, the merchant, in step 940, views his/her home page where multiple options are available to the merchant. For instance, the merchant may, in step 942, create a new mailer/offer. In this case, the flow moves back to step 902 and continues as previously described. Alternatively, the merchant may choose to activate a “dashboard” program in step 944. The dashboard can be accessed from a merchant computer but runs on a hosted platform managed by the inventor and provides continuous or otherwise periodic feedback on active offers. The feedback can include, but is not limited to, identification of recipients activating the offers, goods or services purchased on ticket with offer, time, date, and location of offer redemption, and many others.

An alternative option for the present invention is a sponsored product, where a central identity provides the creative and demographic development for the initial mailing. The “sponsor” can provide, but is not limited to, the distribution list, the creative concept, the costs to participants, and all of the offers. The sponsor sets up a “sponsored product” and controls access to the particular product through the use of a Group Code. An example of a sponsored product would be a situation where a company, COMPANY, is looking to increase membership. COMPANY sponsors a product, chooses the demographics that they wish to target, and the date for distribution. A group code would be generated for them to send to their preferred partners to partake in the program. COMPANY will have the option to absorb all of the cost or some of the cost as an incentive for their preferred partners to sign up.

Referring to flow shown in FIG. 9, retailers that choose to sign up for the sponsored product would select, in step 946, “sponsored product” from the main page 900. The retailer would then be asked to enter their group code in step 948, the group code being directly associated with the product for which they are looking. If the retailer inputs a code that is not in the system, the retailer will be notified of this fact in step 950. Once a correct code is entered, the retailer will be asked to enter a confirmation code in step 952. This confirmation code exists to make sure the particular retailer has registered with the program. If an incorrect code is entered, the retailer will be notified in step 954. The retailer will have an option at this time to register, thus enabling the retailer to move to the next step, step 958, where the retailer uploads its artwork. After artwork is uploaded, the retailer has the option to partake in secondary marketing actions in step 960 if allowed by the group leader.

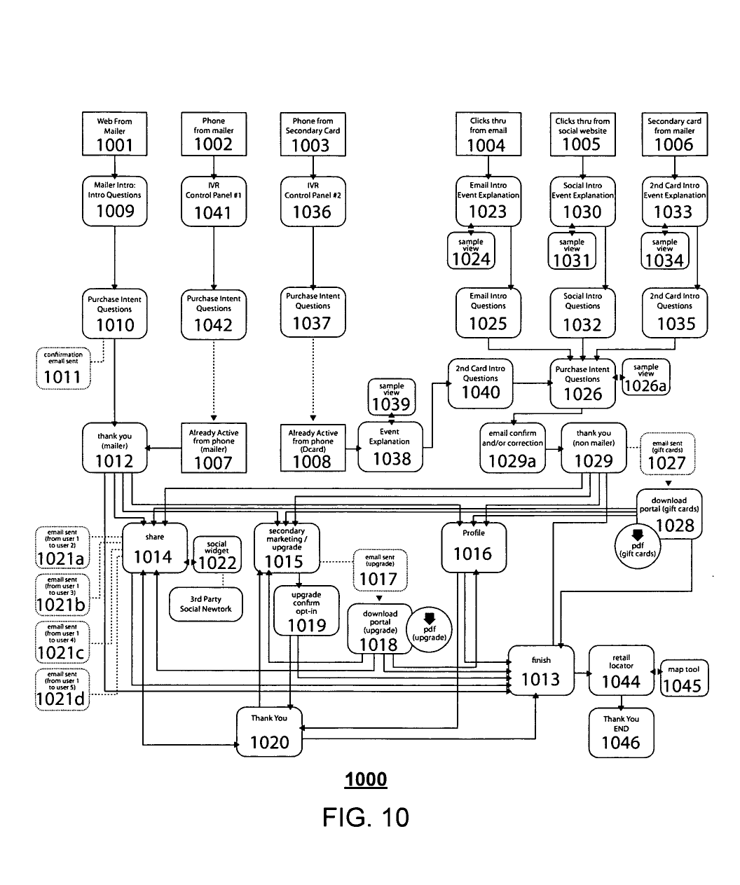

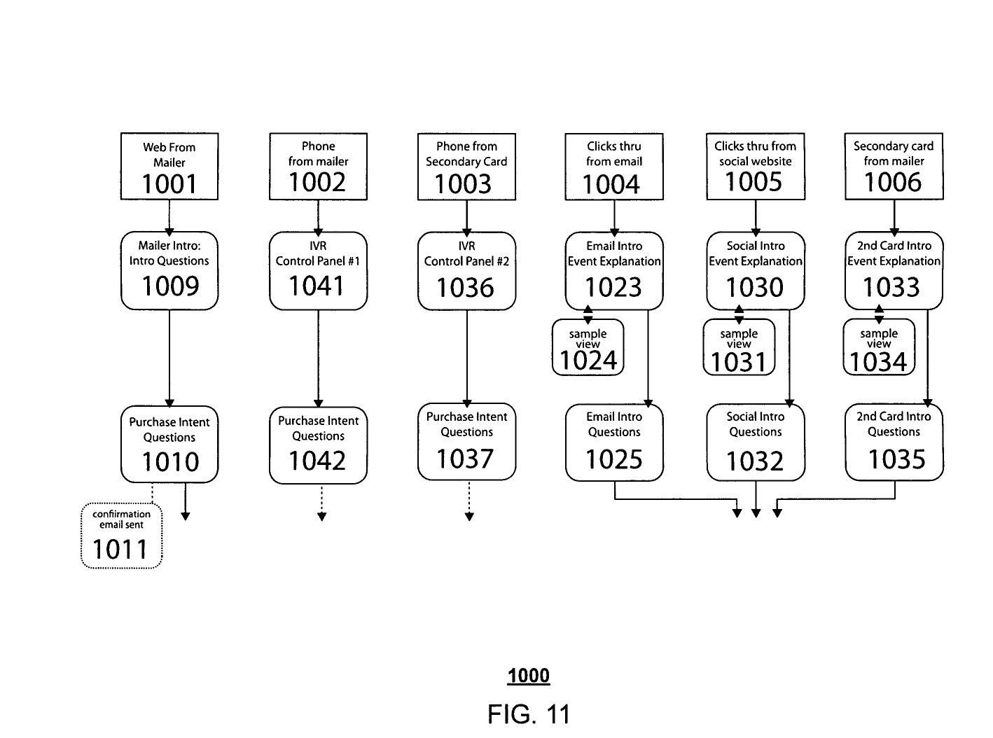

FIG. 10 is an exemplary process flow diagram of an activation site, e.g., a personalized URL, that a consumer would navigate to activate his/her cards and possibly disseminate the cards through email or Internet, e.g., social applications. FIGS. 11-13 show focused sub-steps of the overall activation process 1000 shown in FIG. 10.

Referring now to FIG. 10, card “activation” 1000 is shown in its entirety. (“Activation” can be defined as the process for a customer to acknowledge an offer. Activation is not necessarily required for the offers to be used. Activation is a perceived value to encourage data gathering from a consumer. This process is not meant to limit the current product by producing it in an inactive state, although that is an option this product offers.)

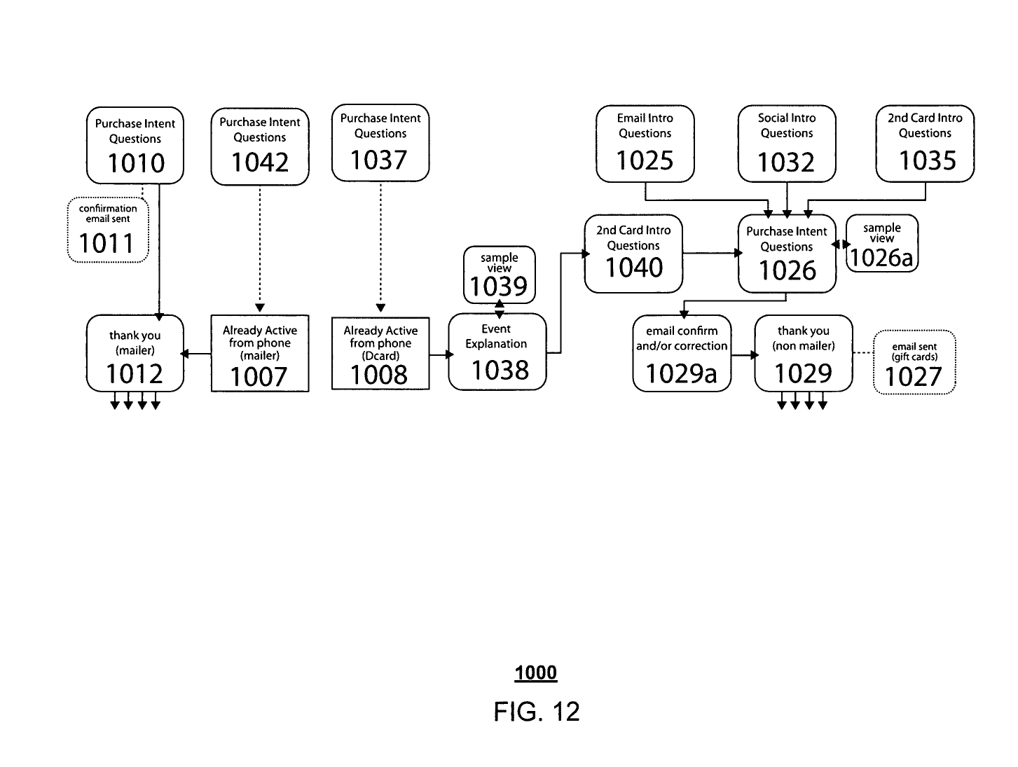

A consumer has several ways to activate the cards in this system. This example shows eight different windows into the site, depicted as steps 1001, 1002, 1003, 1004, 1005, 1006, 1007, and 1008 (see FIG. 12). The most common entry will likely be step 1001, entry into the activation site directly from the mailer. Each mailer will have an entry into the activation site. The entry in this example is a personalized URL, but could be a static URL, or other entry not yet defined.

In this example, step 1009 will confirm the name of the recipient and start asking for more information. In the next step, 1010, the customer will be asked what products he/she intends to purchase. For example, if customer receives mailer 100, shown if FIG. 1, the purchase intent questions could revolve around APPLEBEE′S®, BUFFALO WILD WINGS®, THE HOME DEPOT®, CIRCUIT CITY®, etc., and he/she will have the option to select as many companies that he/she feels encouraged to shop or that interest him/her and from which he/she may potentially purchase.

Once the intent questions are completed, an email will be sent to the customer confirming his/her “activation” status of his/her offer cards (1011). The next step, 1012, thanks the customer and also confirms that the customer's cards are “now active.” That customer then has four options. He/she can, in step 1013, select to finish, which would end the activation process. He/she can, in an alternative step 1014, share the offers with others, or, in a third alternative step 1015, “upgrade” his/her offers or, in the fourth alternative step 1016, create a profile.

Step 1015, upgrading offers, or secondary marketing options is a platform that allows consumers to communicate their wants directly to advertisers either through comments or pre-set selection menus provided by the advertisers. Essentially, these offers can be used to define customer profiles and overall effectiveness of offers on consumers. A true “A, B” testing platform giving advertisers that much more information regarding offer penetration and effectiveness.

If the consumer selects step 1015, once these secondary offers have been completed, an email can be sent to the consumer in step 1017 with a link allowing the consumer access to a printable version of his/her new offers in step 1018, the “download portal”. This download portal brings the consumer back to the system, giving them the same four options they had originally in step 1012: share, upgrade, create a profile, or finish.

When the customer finishes the secondary offers on page 1015, they will be redirected to a confirmation page, step 1019, that allows the consumer to double check the secondary offers selected. Once complete, the consumer will be redirected to a thank you page in step 1020. From the thank-you page, the consumer will have the same four options as before, to finish (step 1013), to share (step 1014), to upgrade (1015), or to create a profile (step 1016).

Selecting step 1014 and sharing of offers allows the customer to send messages to friends via email, social networks, text messages, phone messages, etc. In the example illustrated in FIG. 10, an email and social network platform for sharing the offers is shown. The consumer shares with four other consumers in steps 1021a-d via email as well as posting a link to their social network using features of the present invention in step 1022. After the emails are sent, the consumer is reverted to the thank you page, step 1020, where he/she has the same four options as before, to finish (step 1013), to share (step 1014), to upgrade (1015), or to create a profile (step 1016). When the current user shares, the offers are sent to the user's social network and a link is placed on that social site. When the user closes out of his/her social site, the user will be directed back to the original share page.

Recipients of the email will be directed into the activation site through entry step 1004. The initial landing page on which the second consumer arrives, step 1023, will give an explanation of the site, as well as how the second consumer arrived at the site. For example, it will state that user 1 (consumer) sent them an email and planned on using the offers. It will also have a link, step 1024, that shows how the original offer mailer looked, to give the second consumer a better understanding of the product and offers he/she is going to receive. In step 1023, the second consumer will have the option to participate in the program by clicking “next,” which sends them to step 1025. There, any missing information (address, phone, etc) can be gathered to complete registration, essentially directing them to the purchase intent questions of step 1026. After the second consumer finishes the purchase intent questions in step 1026, he/she will be directed to an email confirmation page, step 1029a, that confirms the email address to which the offers will be sent. Once confirmed, the second consumer will be directed to a thank you page, step 1029. From the thank you page, the second consumer will have the same four options as before, to finish (step 1013), to share (step 1014), to upgrade (1015), or to create a profile (step 1016). As soon as the second consumer confirms his/her email address, an email will be sent, step 1027, with a link to the download portal, step 1028, where the second consumer will be able to download a printable version of the offers. The second consumer will also be able to finish (step 1013), to share (step 1014), to upgrade (1015), or to create a profile (step 1016). The printable version of the offer can have variable information so the system/advertiser can track the new user back to the original mail recipient.

Visitors entering the activation site via a social network are funneled into the system through entry step 1005. The initial landing page the visiting consumer arrives on, step 1030, will give an explanation of the site, as well as how the visiting consumer arrived at the site. For example, it will state that the visiting consumer came from User 1's social network. It will also have a link, step 1031, that shows how the original offer mailer looked, to give the visiting consumer a better understanding of the product and offers the visiting consumer is going to receive. In step 1030, the visiting consumer is provided the option of participating in the program by clicking “next,” which sends them to step 1032. There, any missing information (address, phone, etc) can be gathered to complete his/her registration, essentially directing them to the purchase intent questions of step 1026. After the visiting consumer finishes the purchase intent questions in step 1026, he/she will be directed to an email confirmation page, step 1029a, that confirms the email address to which the offers will be sent. Once confirmed, the visiting consumer will be directed to a thank you page, step 1029. From the thank you page, the visiting consumer will have the same four options as before, to finish (step 1013), to share (step 1014), to upgrade (1015), or to create a profile (step 1016). As soon as the visiting consumer confirms his/her email address, an email will be sent in step 1027, which includes a link to the download portal, step 1028, where the visiting consumer will be able to download a printable version of the offers. The visiting consumer will also be able to finish (step 1013), to share (step 1014), to upgrade (1015), or to create a profile (step 1016). The printable version of the offer can have variable information so the system/advertiser can track the new user back to the original mail recipient.

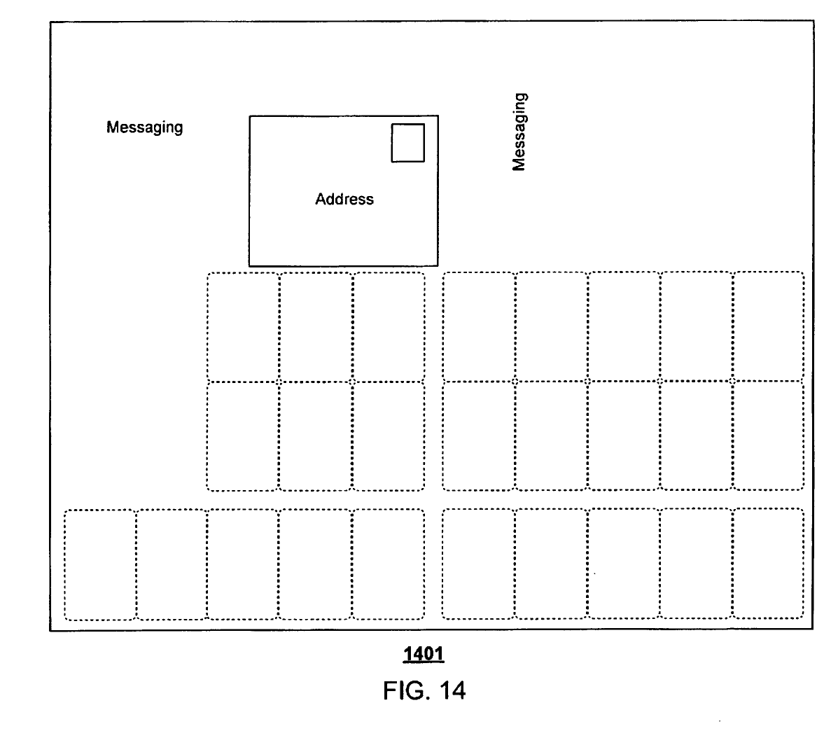

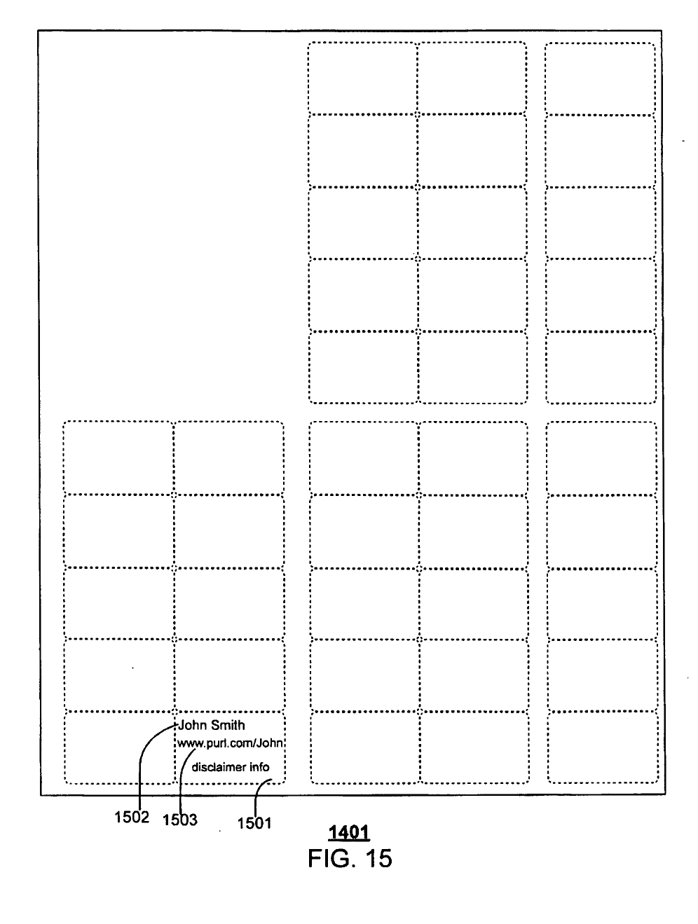

The offer card system can have an optional card within the printed version that allows the offer campaign to spread virally off-line. For instance, FIG. 14 shows an exemplary card 1401. An example of how card 1401 might be used would be, for instance, one where the original mail recipient, User 1, shows all the offers to a friend, User 2. User 1 is going to use the offers, so he cannot give them to User 2. Instead, User 1 gives User 2 the viral card 1401. User 2 can now, for instance, input a purl 1503 (personalized in this example but could be static), shown in FIG. 15, located on a back side of the card 1501.

User 2 can enter the activation site through entry step 1006 shown in FIG. 10. The initial landing page on which the consumer arrives, step 1033, will give an explanation of the site, as well as how User 2 arrived at the site. For example, it will state that User 1 gave User 2 a card from User 1's original mailer so that User 2 could partake in the program. It will also have a link, step 1034, that shows how the original offer mailer looked, to give User 2 a better understanding of the product and offers he/she is going to receive. In step 1033, User 2 has the option of participating in the program by clicking “next,” sending User 2 to step 1035. There, any missing information (address, phone, etc) can be gathered to complete User 2's registration, essentially directing User 2 to the purchase intent questions of step 1026. After User 2 finishes the purchase intent questions in step 1026, he/she will be directed to an email confirmation page, step 1029a, that confirms the email address to which that the offers will be sent. Once confirmed, User 2 will be directed to a thank you page, step 1029. From the thank you page, User 2 will have four options: to finish (step 1013), to share (step 1014), to upgrade (1015), or to create a profile (step 1016). As soon as User 2 confirms his/her email address, an email will be sent, in step 1027, with a link to the download portal, step 1028, where User 2 will be able to download a printable version of the offers. User 2 will also be able to finish (step 1013), to share (step 1014), to upgrade (1015), or to create a profile (step 1016). The printable version of the offer can have variable information so the system/advertiser can track the new user back to the original mail recipient. This card 1601 could also have a phone number that directs User 2 to activate the cards via phone entering the system at 1003.

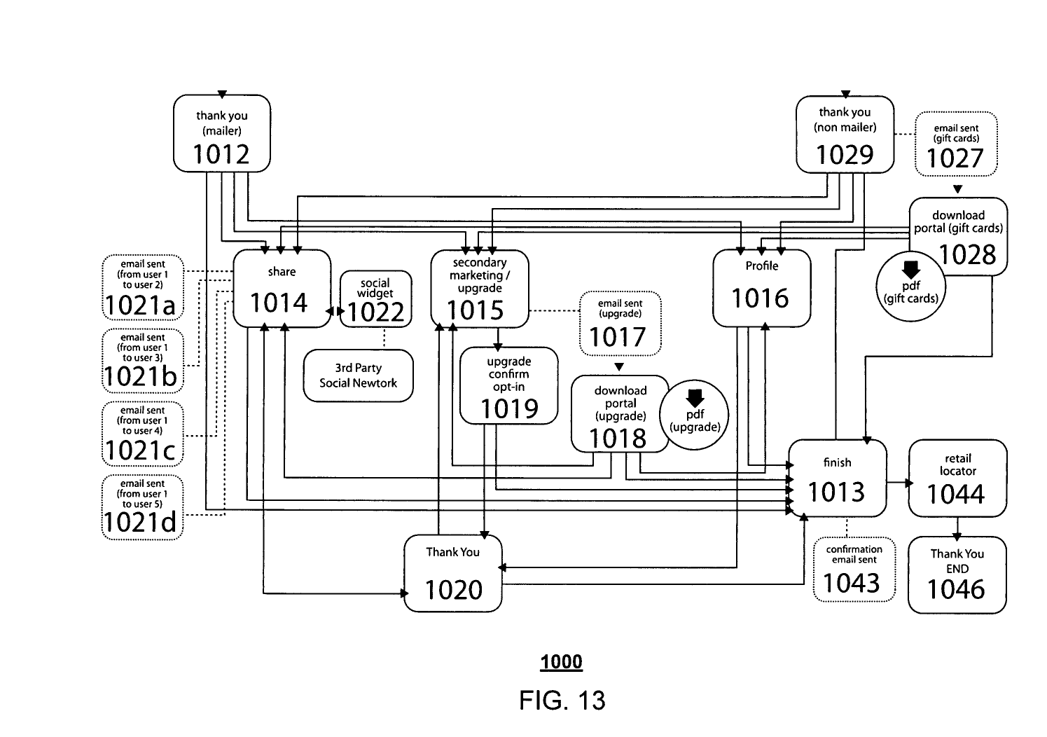

Using interactive voice recognition technology, IVR, responses given by a user can be recorded and processed into the database system, step 1036, pulling information like (but not limited to) name, email address, home address, phone numbers, as well as purchase intentions, step 1037 shown in FIG. 11. Once the data is gathered, the end user is directed to enter the website at entry step 1008, shown in FIG. 12, to begin the download process of their activated cards. The initial landing page the user views, step 1038, gives an explanation of the program, just in case the user did not totally understand the program up to this point. Here they can view a sample of the mailer via step 1039. Once step 1038 is completed, the user will be directed to step 1040 to gather additional information that might have been missed on the IVR process or in case the IVR process is skipped. There, any missing information (address, phone, etc) can be gathered to complete their registration, essentially directing the user to the purchase intent questions of step 1026. After the consumer finishes the purchase intent questions in step 1026, he/she will be directed to an email confirmation page, step 1029a, that confirms the email address to which the offers will be sent. Once confirmed, the user will be directed to a thank you page, step 1029. From the thank-you page they will have the same four options as before: to finish (step 1013), to share (step 1014), to upgrade (1015), or to create a profile (step 1016). As soon as the user confirms his/her email address, an email will be sent, in step 1027, with a link to the download portal, step 1028, shown in FIG. 13, where they will be able to download a printable version of the offers. They will also be able to finish (step 1013), to share (step 1014), to upgrade (1015), or to create a profile (step 1016). The printable version of the offer can have variable information so the system/advertiser can track the new user back to the original mail recipient.

Original recipients of the mailer can activate their cards by using a phone as well, entering the system at step 1002. Using IVR technology, steps 1041 and 1042 shown in FIG. 11, responses given can be recorded and processed into the database system, pulling information like (but not limited to) email address, phone numbers, as well as purchase intentions. Once the data is gathered, the end user is directed to enter the website at 1007, where the end user will have the ability to finish (step 1013), to share (step 1014), to upgrade (1015), or to create a profile (step 1016).

Creating a profile, step 1016 shown in FIG. 10, gives consumers a social interface to communicate to advertisers their wants and needs on a regular basis. When a profile is created, user information is stored, including, but not limited to, age, previous purchase intent answers, psychographic profiles, marital status, revenue, family size, and anything else that might be gathered during the activation process or through communication with advertisers. This will build into a platform of “social sharing” that will be controlled in a database by the overall system. When profile questions are complete, the user will be directed to a thank you page, step 1020, where he/she will have the options to finish (step 1013), share (step 1014), upgrade (1015), or create a profile (step 1016).

The current activation site 1000 can be a continuous loop through step 1020, allowing a user to share and email to an unlimited number of recipients until the user either decides to quit out of the program or to “finish.”

When selecting “finish,” the consumer will be sent to a finish page, step 1013 shown in FIG. 10. Once arriving at the finish page, an email, step 1043, will be automatically generated and sent to the consumer with a full report of activations, upgrades, and shared values in which the consumer participated during his/her recent visit. Step 1044 will contain links to of all the advertisers on the current promotion that associate directly with the map tool, step 1045. The map tool, step 1045, will combine the consumer's location information and generate the closest retail location (or multiple locations) for the advertiser selected. Options for the user to forward the driving directions and map to their mobile device or print the directions can be provided. When the map tool closes out, the consumer will be back on the retail locator, step 1044.

When complete, the consumer can select “done” or simply close out of the program, which sends the consumer to a thank you page, step 1046.

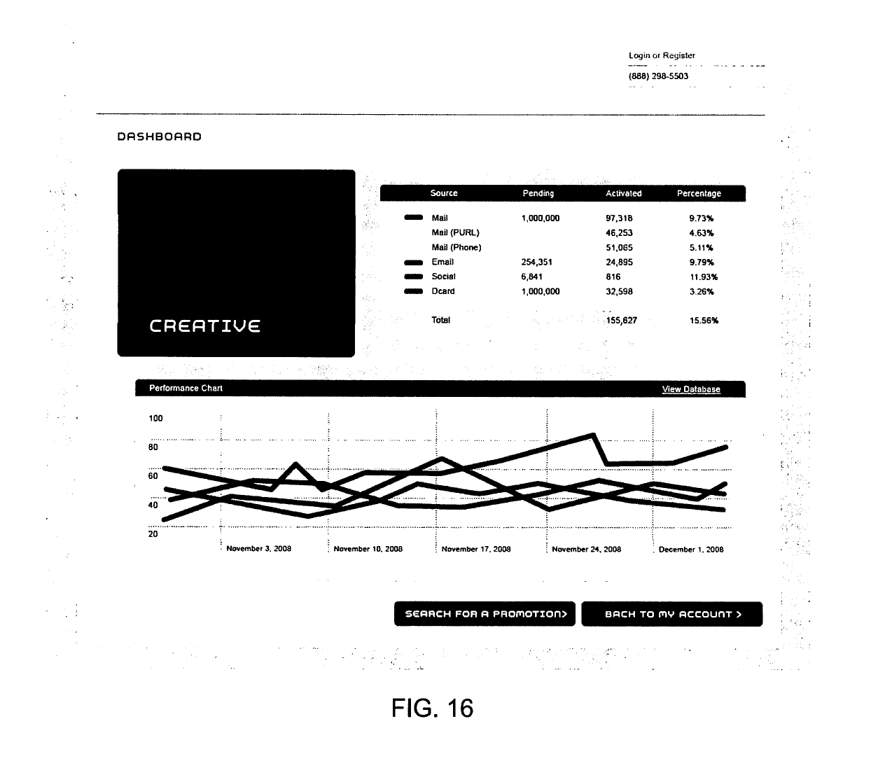

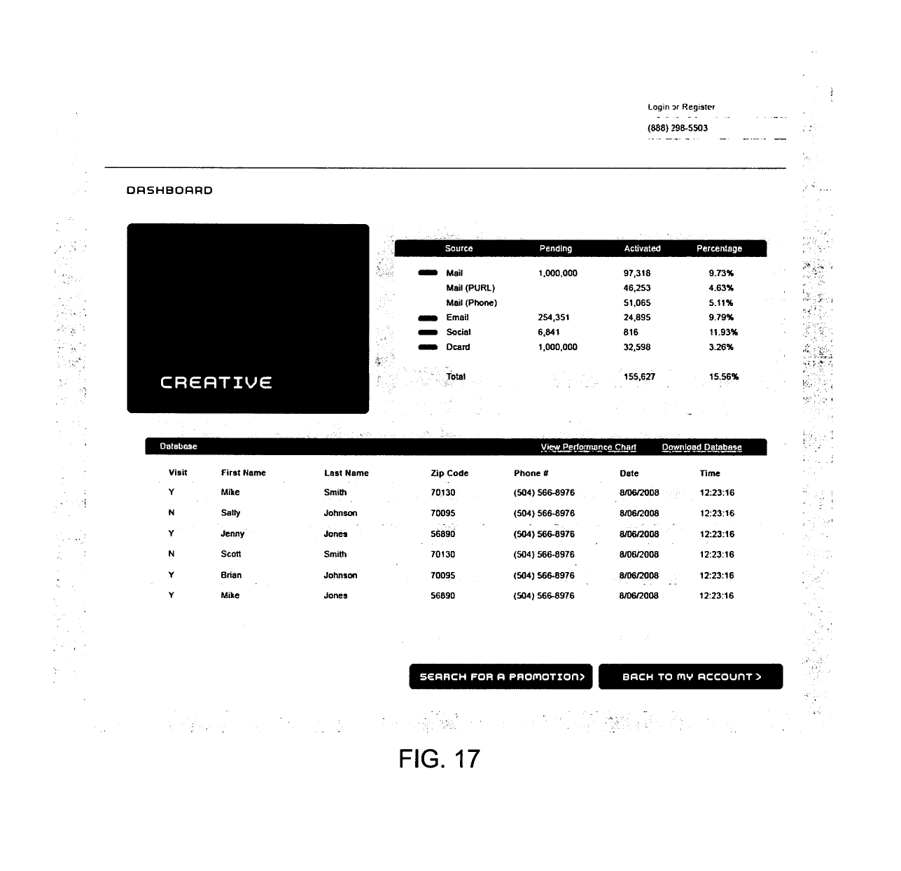

FIGS. 16 and 17 are exemplary snap shots of reports showing illustrating campaign results.

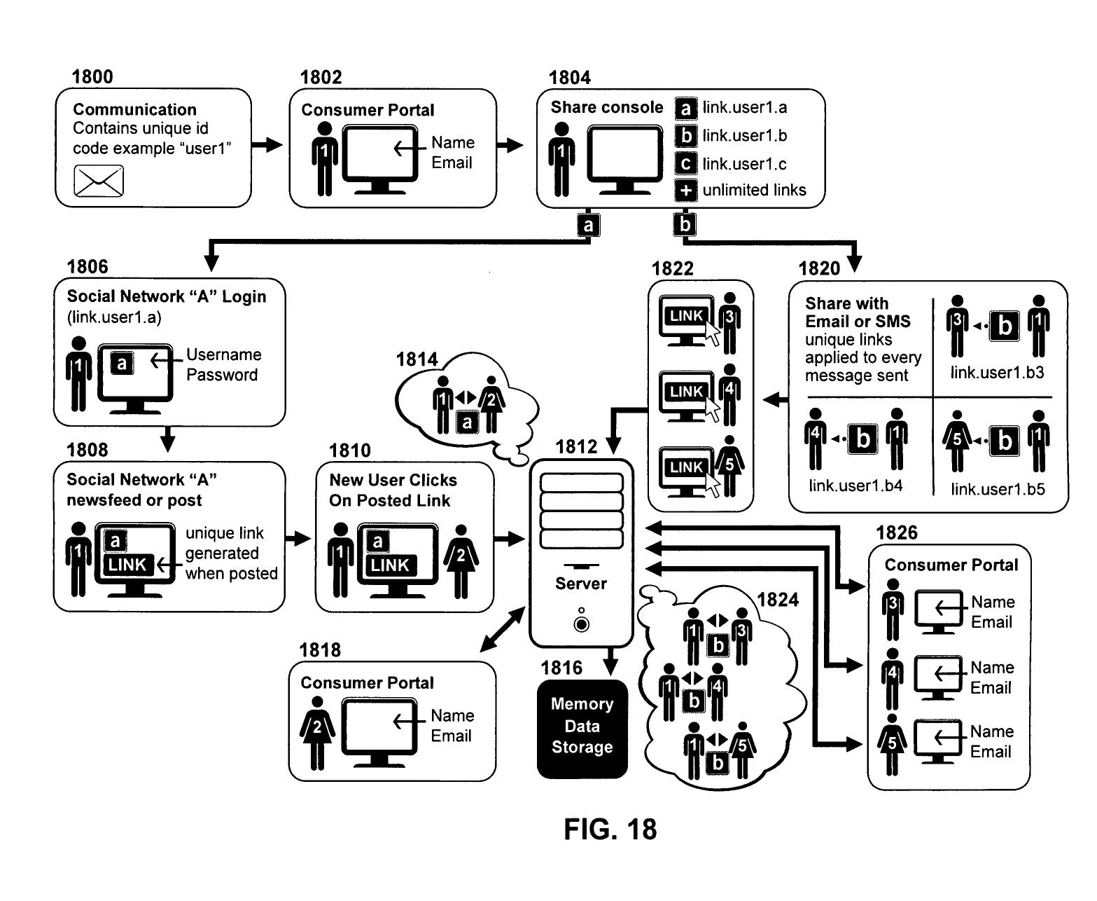

FIG. 18 shows a process flow diagram that further describes a sharing option, similar to that performed in steps 1014 and 1022 of FIG. 10, in accordance with an exemplary embodiment of the present invention. The flow starts at step 1800 where an offer (or a communication) is presented to a consumer. The offer can be a physical medium (such as a mailer, magazine or newspaper ad, billboard), a broadcast medium (such as television or radio) or a virtual medium (such as an email, text message, instant message, or web page) offering a redeeming user, for instance, a discount amount, a discount percentage, a multiple quantity offer, a credit amount, a purchase offer, or other similar offers. The offers generally provide a benefit to the consumer, causing them to act, and may or may not include a retail shopping protocol. In step 1802 the consumer initiates response to the offer by either supplying or confirming his or her personal information. The consumer then, in step 1804, submits an election to “share” the offer. User 1 has the ability to share this offer on all available networks as well as text messaging to mobile devices. Upon electing the share the offer, the consumer, in step 1806, selects one or more “modes” for sharing the offer. Exemplary modes are email, text messaging, instant messaging, or posting to a social network, such as FACEBOOK, TWITTER, MYSPACE, or any other service that allows users to post and/or determine content of personal pages locatable via the internet.

In step 1806, User 1 decides to use Social Network “A” as his or her mode of sharing. The user is provided, a unique dynamically generated uniform resource locator (URL) referred to herein as a personal URL or “PURL.” “Dynamically,” as used herein, is intended to indicate a URL that is electronically created, via an electronic processing device, upon receiving an indication from a user that sharing of a PURL is desired and, as described below, contains information pertaining to the user, the offer, the sharing, or all three. URLs are well known in the art. The PURL, in one embodiment of the present invention, can include random numbers and letters that are unique to the system as well as the individual that posted the link. The exemplary URL structure can include information identifying the offer, information identifying the consumer, the generation of sharing the user is associated with, information identifying the sharing mode, e.g., a particular social network, and can also include additional information or less information. For instance, if the offer is for a discount on products from the ACME company, the consumer is John Smith, and the selected mode is the social network FACEBOOK, the specific PURL could be www.acmeoctober20percentoff/jsmith4345/fb.com, where “acmeoctober20percentoff” is a code that identifies the offer, “jsmith4345” is a code that identifies the user, and “fb” is a code that identifies the selected mode for sharing the offer, in this case FACEBOOK. This PURL is merely exemplary and the present invention is in no way limited to a particular format or content of information.

Next, in step 1808, a link is placed on the consumer's selected mode, in this case, a social network. The link, in one embodiment, is not displayed as the actual PURL, but is, instead, a graphical target, such as a picture, box, or other target that can be clicked on or otherwise selected by a user and causes the system to register it as a selection made by a visitor. In some embodiments, the visiting user is unable to obtain, i.e., determine, the actual PURL. This determination can be accomplished, for instance, through use of an alias URL. For instance, the PURL “www.acmeoctober20percentoff/jsmith4345/fb.com” can be converted to “www.alias.com/code3,” which may be discoverable by the visitor. The URL conversion can be through, for example, TINYURL, which is web service that provides short aliases for redirection of long URLs.

In step 1810, a secondary user of the consumer's social site page selects the link. This selection is performed by “clicking” on the on the PURL, which includes utilizing a graphical user interface to select the PURL's graphical representation, alias, or any other selection method. In step 1812, a message is transmitted through the connecting element 412 of the network 400 to the server 404. The transmitted message contains information that identifies the consumer that posted the PURL, the offer being shared, and the mode of sharing. The server then, in step 1816 records the event in memory 509. By recording the event, the system can track a user's influence at generating interest in offers. This is shown as a thought cloud in step 1814, showing the server now associates user 1 with user 2.

Returning back to step 1804, if the consumer chooses to share the offer via email or text message, in step 1820, a unique dynamically generated PURL is created and placed within an email or text message template. Again, the link placed within the email or text message does not necessarily reflect the actual PURL. It can be, for example a graphical target, such as a picture, box, or other target that can be clicked on or otherwise selected by a user. Additionally, an alias URL can be substituted for the actual PURL.

In step 1820, the consumer designates the recipient(s) of the email or text message and selects “send,” which transmits it to the designated recipient(s). It should be noted that the email can also include text, graphics, multimedia objects, other objects, or a combination thereof that enhances the email and generates interest in the recipient. A text message can include descriptive text. In step 1822, the recipient selects the enclosed link, where the flow then returns to step 1812 where a message is transmitted through the connecting element 412 of the network 400 to the server 404. Each recipient is processed and run through the platform with their dynamically created micro site. The server stores the data collected and has determined the relationship between the multiple recipients (step 1824) through the dynamically created link.

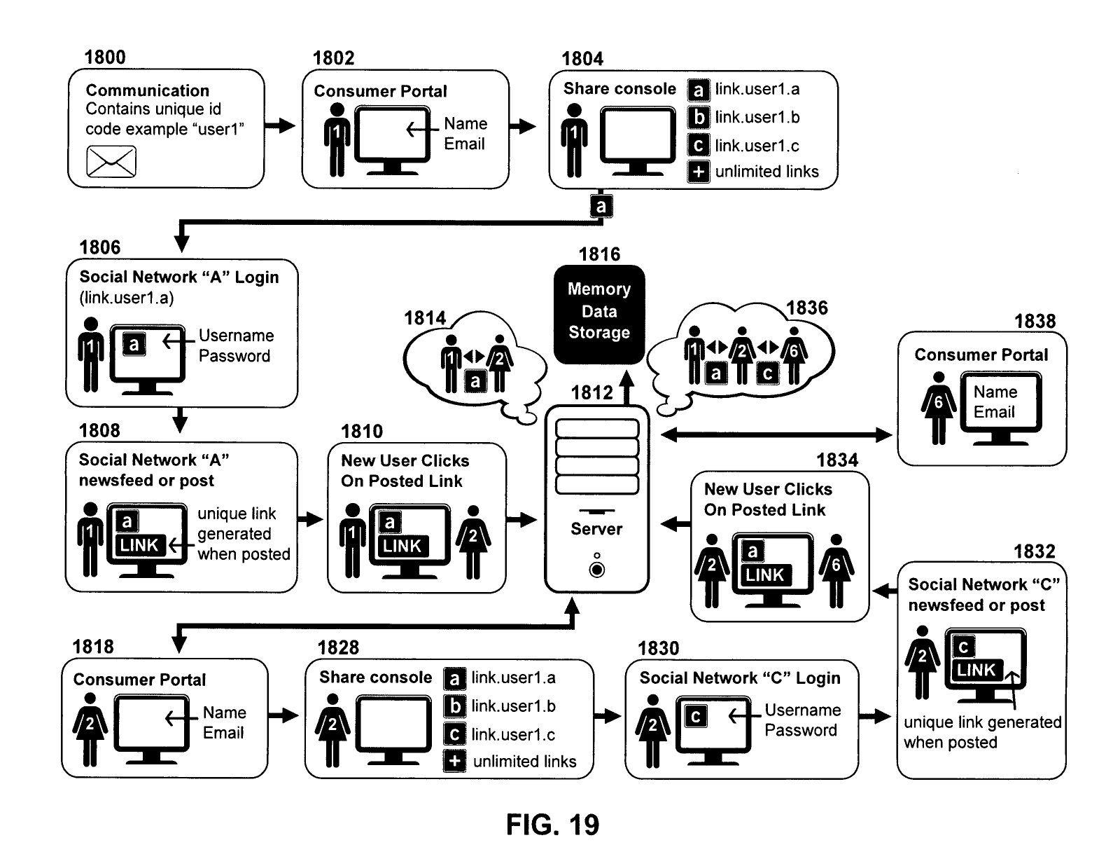

The process flow chart of FIG. 19 shows how the system can track several generations of sharing. In the steps following step 1810, according to embodiments of the present invention, that occur after the visitor selects the dynamically generated PURL. In step 1818, the visitor is presented with a web page that invites the visitor to submit personal information, such as name, address, email address, and other information, so that the visitor can redeem the offer. When the visitor submits the information to the system the information is stored in memory 509. (Step 1814) According to the present invention, this link between the visitor and the consumer, whose link the visitor followed, can be used and amended as necessary to rate the posting consumer's “social influence.” This influence rating can be used to reward the posting consumer in multiple ways, such as financially, providing discounts and other offers to the consumer, providing free goods and services to the consumer, or other rewards.

Once the redeeming visitor provides his or her personal information in step 1818, the redeeming visitor then, in step 1828, submits an election to “share” the offer. Upon electing the share the offer, the redeeming visitor, in step 1828, selects one or more “modes” for sharing the offer. Once the mode of sharing is selected, in step 1830, the user logs in to the selected network. Next, the redeeming visitor is provided, in step 1832, with his or her own unique dynamically generated PURL. The new PURL, in one embodiment of the present invention, will include a structure such as: www.offerurl.com/redeemingvisitorID/sharingmodeID. The exemplary structure can include information identifying the offer, information identifying the redeeming visitor, information identifying the sharing mode, e.g., the particular social network, additional information or less information. The new PURL can also include information identifying the consumer whose link the redeeming user used to redeem the offer.

Next, in step 1834, a link is placed on the redeeming visitor's selected mode, e.g., a social network, and is available for acceptance by a second redeeming visitor. Once redeemed by a second redeeming visitor, the flow moves back up to step 1812 where a message is transmitted through the connecting element 412 of the network 400 to the server 404. The process can continue on and on, increasing users exponentially and spanning over many different modes of sharing. Step 1836 shows how the server relates User 6 to User 1 indirectly through sharing. This generational tracking allows retailers to see the number of people one User influences, exponentially through every generation of sharing.

In summary, the social influence of each user along the chain can be monitored and tracked over various iterations of sharing. In this way, a single share can create a pyramid effect and can lead to great rewards for each sharer, depending on the particular reward system in place. The most influential sharers are likely attractive targets for further offers and rewards from venders.

What is claimed is:

1. A method for stimulating commerce, the method comprising:
presenting an offer to a consumer;
receiving from the consumer an identifier of a selected mode for sharing the offer;
dynamically generating a unique URL, the unique URL including at least:
an identifier of the consumer;
the identifier of the selected mode for sharing the offer; and
an identifier of the offer;
placing the dynamically-generated URL in the selected mode for sharing the offer, the dynamically-generated URL being selectable by a user; and
electronically sharing the offer via the selected mode.

2. The method according to claim 1, wherein the selected mode is one of:
a social network;
a text message;
an instant message; and
an email.

3. The method according to claim 1, further comprising:
receiving, via an electronic network, an indication of a selection of the dynamically-generated URL by the user; and
receiving the identifier of the offer and at least one of:
an identifier of the user;
the identifier of the consumer; and
an identifier of a social network.

4. The method according to claim 3, further comprising:
receiving from the user, via the electronic network, an identifier of a new mode for sharing the offer;
dynamically generating a second unique URL, the second unique URL including the identifier of the offer and at least one of:
an identifier of the user;
the identifier of the consumer; and
the identifier of the new mode for sharing the offer; and
placing the second dynamically-generated unique URL on the new mode for sharing the offer, the second dynamically-generated URL being selectable by a second user.

5. The method according to claim 3, further comprising:
receiving from the user an identifier of the selected mode for sharing the offer;
dynamically generating a second unique URL, the second unique URL including the identifier of the offer and at least one of:
an identifier of the user;
the identifier of the consumer; and
the identifier of the selected mode for sharing the offer; and
placing the second dynamically-generated unique URL on the selected mode for sharing the offer, the second dynamically-generated URL being selectable by a second user.

6. The method according to claim 1, wherein the offer comprises:
a tangible medium; and
at least one card coupled to the tangible medium.

7. The method according to claim 1, further comprising:
receiving at least one activation code from the consumer; and
communicating an activation instruction to at least one merchant associated with the offer, in response to receiving from the consumer the identifier of the selected mode for sharing the offer.

8. The method according to claim 1, wherein the receiving and dynamically generating steps are performed at a central server communicatively coupled to a communication network.

9. An economic stimulus system, comprising:
a central server communicatively coupled to a communication network and operable to compose an offer for a consumer; and
a network connection communicatively coupling the consumer to the central server and operable to:
communicate the offer from the central server to the consumer; and
communicate from the consumer to the central server an identifier of a selected mode for sharing the offer,
wherein the central server is further operable to:
dynamically generate a unique URL, the unique URL including at least:
an identifier of the consumer;
the identifier of the selected mode for sharing the offer; and
an identifier of the offer;
place the dynamically-generated URL in the selected mode for sharing the offer, the dynamically-generated URL being selectable by a user; and
electronically share the offer via the selected mode.

10. The economic stimulus system according to claim 9, wherein the selected mode is one of:
a social network;
a text message;
an instant message; and
an email.

11. The economic stimulus system according to claim 9, wherein the central server is further operable to:
receive, via the network connection, an indication of a selection of the dynamically-generated URL by the user; and
receive, via the network connection, the identifier of the offer and at least one of:
an identifier of the user;
the identifier of the consumer; and
an identifier of a social network.

12. The economic stimulus system according to claim 11, wherein the central server is further operable to:
receive, via the network connection, the identifier of a new mode for sharing the offer;
dynamically generate a second unique URL, the second unique URL including the identifier of the offer and at least one of:
an identifier of the user;
the identifier of the consumer; and
the identifier of the new mode for sharing the offer; and
place the second dynamically-generated unique URL on the new mode for sharing the offer, the second dynamically-generated URL being selectable by a second user.

13. The economic stimulus system according to claim 11, wherein the central server is further operable to:
receive from the user, via the network connection, an identifier of the selected mode for sharing the offer;
dynamically generate a second unique URL, the second unique URL including the identifier of the offer and at least one of:
an identifier of the user;
the identifier of the consumer; and
the identifier of the selected mode for sharing the offer; and
place the second dynamically-generated unique URL on the selected mode for sharing the offer, the second dynamically-generated URL being selectable by a second user.

14. The economic stimulus system according to claim 9, wherein the offer comprises:
a tangible medium; and
at least one card coupled to the tangible medium.

15. The economic stimulus system according to claim 9, wherein the central server is further operable to:
receive at least one activation code from the consumer; and
communicate an activation instruction to at least one merchant associated with the offer, in response to receiving from the consumer the identifier of the selected mode for sharing the offer
